(19) United States
(12) Patent Application Publication
(10) Pub. No.: US 2011/0047184 A1
(43) Pub. Date: Feb. 24, 2011

(54) METHOD OF MANAGING CONTACT ITEM INFORMATION, USER DEVICE FOR EXECUTING THE METHOD, AND STORAGE MEDIUM THEREOF

(75) Inventors: Keum-koo LEE, Seongnam-si (KR); Hee-jeong Choo, Anyang-si (KR); Ju-yun Sung, Yongin-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/860,584

(22) Filed: Aug. 20, 2010

(30) Foreign Application Priority Data
Aug. 21, 2009 (KR) 10-2009-0077879

(51) Int. Cl. G06F 17/30

(52) U.S. Cl. 707/792; 707/E17.055

(57) ABSTRACT

A method of managing contact item information includes requesting an external device for contact item information relating to a contact object; receiving the requested contact item information from the external device; and linking the received contact item information to the contact object. A user device that may execute the above method, and a storage medium are also provided.

### PRIORITY

This application claims priority to Korean Patent Application No. 10-2009-0077879, filed on Aug. 21, 2009, in the Korean Intellectual Property Office, the disclosure of which is incorporated herein in its entirety by reference.

### BACKGROUND OF THE INVENTION

1. Field of the Invention

The present invention generally relates to a method of managing contact item information of contact objects, a user device for executing the method, and a storage medium.

2. Description of the Related Art

When a user wants to make a contact with a contact object by using a user device, the user generally inputs contact information directly by using an input unit of the user device or searches for the contact information in an address book or a contact list stored in the user device. For example, if the user device is a mobile phone, the user directly inputs the contact information by using an input unit of the mobile phone or searches for the contact information in an address book or a contact list stored in the mobile phone.

However, the address book or the contact list stored in the user device is based on information input by the user. That is, the address book or the contact list is generated based on data such as names, aliases, home telephone numbers, mobile phone numbers, company phone numbers, and e-mail addresses input by the user. Therefore, contact items included in the address book or the contact list stored in the conventional user device are generally limited to data input by the user.

### SUMMARY OF THE INVENTION

The present invention provides a method of managing contact item information, which provides various contact item information about a contact object, a user device that executes the managing method, and a computer readable recording medium.

According to an aspect of the present invention, there is provided a method of managing contact item information, the method including requesting an external device for contact item information relating to a contact object; receiving the requested contact item information from the external device; and linking the received contact item information to the contact object.

The method further includes linking the contact item information to information about available user devices, and further includes executing a task based on the selected contact item information based on the available user device information.

According to another aspect of the present invention, there is provided a user device including a network interface unit interfacing with a network; and a processor transmitting a signal for requesting contact item information relating to a contact object to an external device through the network interface unit, and linking the contact item information that is transmitted through the network interface unit to the contact object.

According to another aspect of the present invention, there is provided a computer readable recording medium having embodied thereon a computer program for executing the method of managing the contact item information.

### BRIEF DESCRIPTION OF THE DRAWINGS

The above and other features and advantages of the present invention will become more apparent by describing in detail exemplary embodiments thereof with reference to the attached drawings in which:

FIG. 1 is block diagram of a user device according to an embodiment of the present invention;

FIG. 2 is a diagram showing an example of contact item information list, according to the embodiment of the present invention;

FIG. 3 is a diagram showing an example of a sub-contact item information list in the contact item information list shown in FIG. 2;

FIG. 4 is a diagram showing another example of the contact item information list according to the embodiment of the present invention;

FIG. 5 is a diagram showing another example of the contact item information list according to the embodiment of the present invention;

FIG. 6 is a diagram showing an example of a configuration of network for collecting contact item information included in the contact item information list, according to the embodiment of the present invention;

FIG. 7 is a diagram showing another example of a configuration of network for collecting contact item information included in the contact item information list, according to the embodiment of the present invention;

FIG. 8 is a diagram showing another example of a configuration of network for collecting contact item information included in the contact item information list, according to the embodiment of the present invention;

FIG. 9 is a flowchart illustrating a method of managing contact item information in a user device, according to an embodiment of the present invention;

FIG. 10 is a diagram illustrating a method of selecting a contact object by using contents based on images, according to the embodiment of the present invention;

FIG. 11 is a diagram illustrating a method of selecting a contact object based on a contact list, according to the embodiment of the present invention;

FIG. 12 is a diagram showing a screen, on which the contact list is displayed, according to the embodiment of the present invention;

FIG. 13 is a flowchart illustrating a method of managing contact item information in a user device, according to another embodiment of the present invention;

FIG. 14 is a flowchart illustrating a method of managing contact item information in a user device, according to another embodiment of the present invention;

FIG. 15 is a flowchart illustrating a method of managing contact item information in a user device, according to another embodiment of the present invention;

FIG. 16 is a flowchart illustrating a method of managing contact item information in a user device, according to another embodiment of the present invention;

FIG. 17 is a flowchart illustrating a method of managing contact item information in a user device, according to another embodiment of the present invention; and

FIG. 18 is a flowchart illustrating a method of managing contact item information in a user device, according to another embodiment of the present invention.

### DETAILED DESCRIPTION OF EMBODIMENTS OF THE INVENTION

Hereinafter, embodiments of the present invention will be described in detail with reference to accompanying drawings.

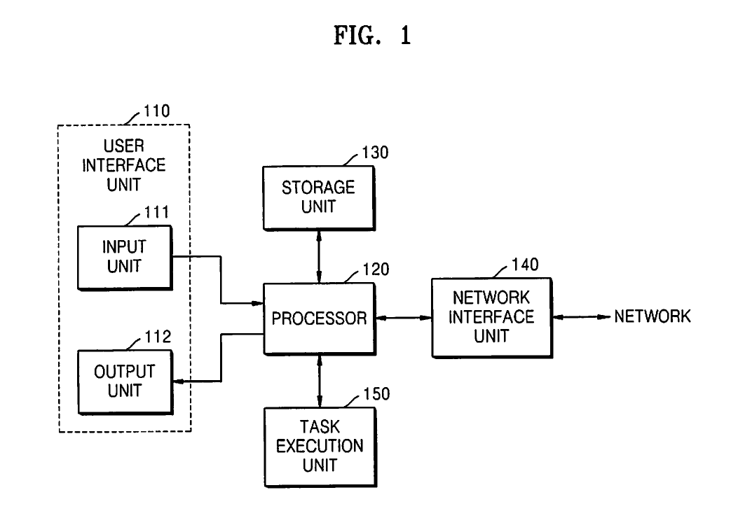

FIG. 1 is a block diagram of a user device 100 according to an embodiment of the present invention. The user device 100 may be connected to a network by wire or wirelessly. The user device 100 may be a device such as a computer, a mobile device, and an Internet Protocol TV (IPTV). The mobile device may be a portable device such as a mobile phone, a Smartphone, an iPhone, a Personal Digital Assistant (PDA), a Portable Multimedia Player (PMP), a navigation device, and a game console. The IPTV may be included in the mobile device. The IPTV can be defined as a terminal for digital broadcasting.

The user device 100 includes a user interface unit 110, a processor 120, a storage unit 130, a network interface unit 140, and a task execution unit 150. The user device 100 may be realized by more components or less components than the components shown in FIG. 1. For example, the user device 100 may not include the task execution unit 150, and the processor 120 may include the storage unit 130 or the network interface unit 140.

The user interface unit 110 includes an input unit 111 and an output unit 112. A user of the user device 100 may input information or commands by using the input unit 111. The information or commands that may be input by the user according to an embodiment of the present invention may include, for example, contact object information, a signal for selecting a contact object, a signal for selecting a contact item of the contact object, and a signal for requesting a contact list. The contact object may be referred to as a contact target.

The input unit 111 may be a touch-based unit, such as a touch panel or a touch screen that generates an input signal (input data) according to a contact position of a finger or a stylus pen. The input unit 111 may be coupled to the output unit 112.

The output unit 112 may display a contact item information list according to an embodiment of the present invention. The contact item information list may include information about all contactable items of the contact object. The contact item information list may be referred to as an integrated contact list, an integrated contact item information list, or a smart contact list.

The contact item information list may be generated based on information of the contact object that is input through the input unit 111 and at least a piece of contact item information received from an external device (not shown). The contact item information list may be generated based on the contact object information and at least a piece of contact item information input through the input unit 111, and at least a piece of contact item information received from the external device. The contact item information list may be generated based on the contact object information and at least a piece of the contact item information received from the external device. The at least a piece of the contact item information received from the external device may be the contact item information about a plurality of contact objects. The external device may be at least one among at least another user device that may be used by the user, a service, and a server, as will be shown in an example of network configuration that will be described later.

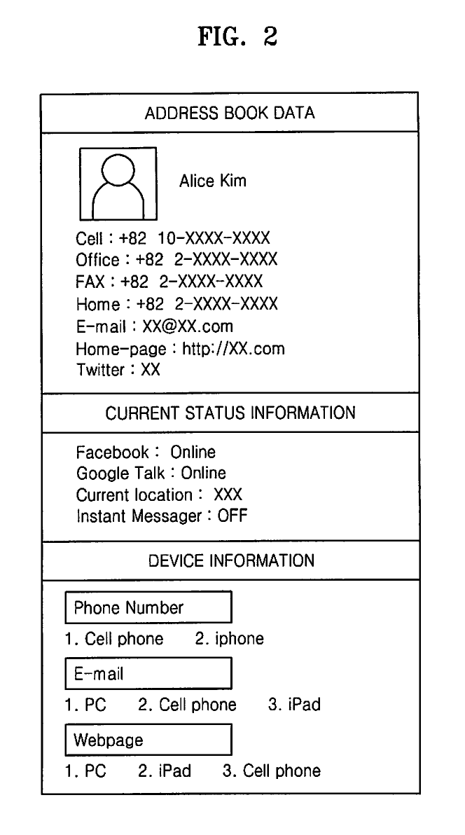

FIG. 2 is a diagram showing an example of the contact item information list according to the embodiment of the present invention. Referring to FIG. 2, the contact item information list includes address book data, current status information, and device information of Alice Kim.

The address book data shown in FIG. 2 includes a cell phone number (cell), an office number (office), a fax number (FAX), home telephone number (HOME), e-mail address (E-mail), home-page address (Home-page), and Twitter address (Twitter). The item information included in the address book data is the contact item information about Alice Kim, that is, the information of the items that are selectable when the user of the user device 100 wants to make a contact with Alice Kim.

The current status information shown in FIG. 2 includes Facebook status information, Google talk status information, current location information, and Instant Messenger status information of Alice Kim. The current location information may be provided based on the device used by Alice Kim currently. Therefore, if Alice Kim does not use any kind of device, the current location information may not be provided.

The device that may provide the current location information of Alice Kim may have a network function and a function of providing location information based on a Global Positioning System (GPS), an Access Point (AP), or a base station. The items included in the current status information may be the contact items of Alice Kim. However, the items included in the current status information may be reference items referred to when the user of the user device 100 makes contact with Alice Kim.

The device information shown in FIG. 2 is information about user devices used in each link type. The available user device is the device that may be used by the user of the user device 100, and may include the user device 100 according to the link type.

In FIG. 2, if the user wants to link the phone number of Alice Kim, the available user device is a cell phone and an iPhone. If the user wants to link the E-mail address of Alice Kim, the available device is a Personal Computer (PC), a cell phone, and an iPad. If the user wants to link the web-page of Alice Kim, the available device is a PC, an iPad, and a cell phone. An order of the devices according to each link type may be set based on at least one of functions included in each of the user devices, a use frequency of the user, and a default value when launching the user device.

The user device 100 tries to make a link based on the contact items of Alice Kim, according to the order of user devices in the selected link type. For example, when the user device 100 is the cell phone and the user selects at least one phone number among the phone numbers included in the address book data, the user device 100 is the prior user device to perform a task for the link based on the phone number.

If the user device 100 is the cell phone and the user selects the E-mail address of Alice Kim, the prior user device to perform a task for the link based on the selected E-mail address is the PC (not shown) of the user, not the user device 100. Therefore, the user device 100 transmits a task execution command based on the E-mail address to the PC of the user. At this time, if the PC is in a turned-off status, the user device 100 may perform the task for the link based on the E-mail address of Alice Kim.

If the user device 100 is the cell phone and the user selects the web-page address of Alice Kim, the prior user device to perform the task based on the selected web-page is the PC of the user. Therefore, the user device 100 transmits a task execution command based on the web-page to the PC of the user. At this time, if the PC of the user is in the turned-off status, the user device 100 transmits the task execution command based on the selected web-page to the iPad of the user. At this time, if the iPad of the user is in the turned-off status, the user device 100 may perform the task based on the selected web-page.

The task based on the device information may be automatically executed by a processor 120 of the user device 100. However, the user device to perform the task may be determined according to a selection signal of the user input through the input unit 111 based on the contact item information list of Alice Kim displayed on the output unit 112.

For example, when information about the available user devices based on the phone number is output as shown in FIG. 2, and the user inputs a command to select iPhone through the input unit 111, the processor 120 transmits the task execution command based on the phone number to the iPhone (not shown) of the user through the network interface unit 140. Accordingly, the iPhone of the user executes the task based on the phone number of Alice Kim.

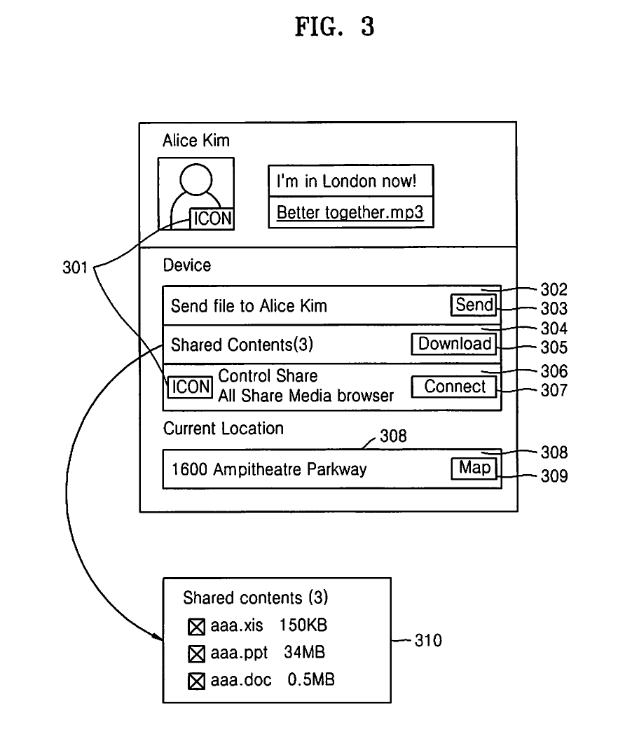

The contact items included in the contact item information list may include sub-contact item information list. For example, when the current location information is provided based on the device used by Alice Kim currently, the user selects the current location information as the contact item information by using the input unit 111, and then, the sub-contact item information list including the sub-contact item information may be output to the output unit 112 as shown in FIG. 3.

FIG. 3 is a diagram showing an example of the sub-contact item information list of the contact item information list shown in FIG. 2. FIG. 3 shows the list provided based on the device used by Alice Kim, who is the contact object. Therefore, if there is no device currently used by Alice Kim who is the contact object, the sub-contact item information list shown in FIG. 3 may not be output to the output unit 112.

Referring to FIG. 3, 301 denotes an icon representing the device currently used by Alice Kim. 302 denotes the contact item information used to transmit a file to Alice Kim. When a button 303 is controlled by the input unit 111, the file may be transmitted to the device of Alice Kim.

304 denotes the contact item information used to download sharable contents from the device currently used by Alice Kim. When a button 305 is controlled by the input unit 111, the sub-contact item information list about the sharable contents may be output to the output unit 112 as shown as 310. The user may select the contents that are desired to be shared by using the input unit 111 based on the displayed sub-contact item information list 310. If there is no content that can be shared, the sub-contact item information list such as 310 may not be output to the output unit 112.

306 denotes the contact item information for selecting remote control of the device used by Alice Kim. When a button 307 is controlled by the input unit 111, the user device 100 may perform the remote controlling of the device used by Alice Kim. When a button 309 is controlled by the input unit 111, detailed map information about the current location of Alice Kim is output to the output unit 112.

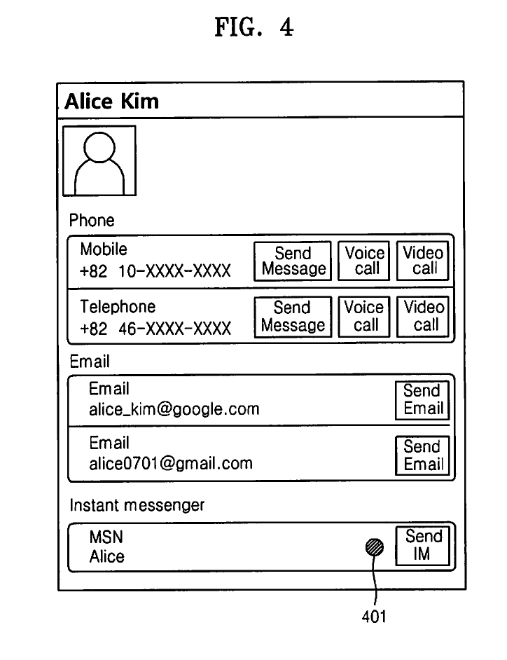

In addition, the address book data and the current status information of the contact item information list may be output as shown in FIG. 4. FIG. 4 shows another example of the contact item information list according to the present embodiment. Referring to FIG. 4, the phone number of Alice Kim may include the mobile phone number and the telephone number, and includes the contact item information for selecting whether a message is transferred, a voice call is to be made, or a video call is to be made by using each of the phone numbers. The E-mail includes the contact item information for selecting which of a plurality of E-mail addresses to be used to transfer an E-mail. The instant messenger represents turning-on/off states of the instant messenger as denoted by indicator 401, and includes the contact item information for transmitting an instant message IM if the indicator 401 denotes the turned on status of the instant messenger.

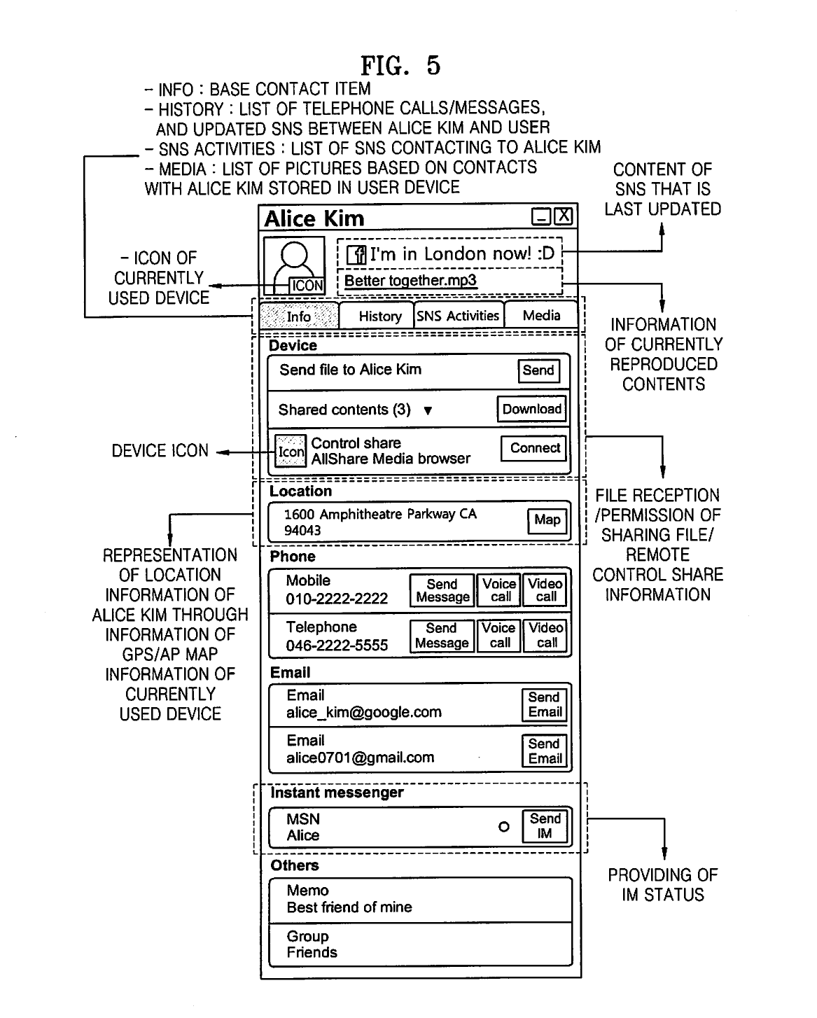

The contact item information list output to the output unit 112 according to the present invention is not limited to the examples shown in FIGS. 2 through 4. If necessary, the contact item information list shown in FIGS. 2 through 4 may be output as a mixed type as shown in FIG. 5. FIG. 5 shows another example of the contact item information list according to the present embodiment.

In addition, as shown in FIG. 5, the contact item information list may include additional items such as a contact history between the user of the user device 100 and Alice Kim, Social Network Service (SNS) activities based on the contact, and picture lists (Media) based on the contacts between the user and Alice Kim stored in the user device 100. The additional items may be generated by the user device 100 based on the contacts to Alice Kim.

FIGS. 2 through 5 show the contact item information lists about Alice Kim for the convenience of description. However, the user device 100 may output the contact item information lists about other contact objects to the output unit 112, similar to the examples shown in FIGS. 2 through 5.

The output unit 112 may display all kinds of boards uploaded on web-sites, Internet cafes, blogs, mini homepages, or homepages received through the network interface unit 140. In particular, Internet contents such as User Created Contents (UCC) may be displayed. The UCC may include all kinds of boards uploaded on the Internet cafes, the blogs, mini homepages, homepages, and web-sites. The User Modified Content (UMC), User Generated Content (UGC), and User Recreated Content (URC) defined by YouTube, U.S.A., may be defined as the UCC.

If the user device 100 is an IPTV, the output unit 112 may display broadcasting programs that are currently received through the network interface unit 140 or stored in the storage unit 130. The user device 100 may further include a unit for receiving the broadcasting program (not shown) in addition to the components shown in FIG. 1. If the unit for receiving the broadcasting program is added to the user device 100, the broadcasting program may be received by the unit and may be output to the output unit 112.

The output unit 112 may be realized by using a Liquid Crystal Display (LCD), a Thin Film Transistor-Liquid Crystal Display (TFT-LCD), an Organic Light-Emitting Diode (OLED), a flexible display, a three-dimensional (3D) display, or an Active-Matrix Organic Light-Emitting Diode (AMOLED).

The storage unit 130 may store application programs and data that are required to perform a method of managing contact item information according to the embodiment of the present invention. The application programs may include programs for executing a communicator, a browser, or a widget based on the contact item information list shown in FIGS. 2 through 5, programs for receiving the broadcasting programs, and programs providing the contact item information list based on the received broadcasting program. The communicator may be referred to as an integrated communicator. In addition, the storage unit 130 may store the information of the user devices that may be connected through the network interface unit 140, and the contact item information list shown in FIGS. 2 through 5 according to the contact objects. That is, the storage unit 130 may store the contact item information list of at least one contact object.

The network interface unit 140 is controlled by the processor 120 to access a wired or a wireless network to receive the contents from a certain website, the Internet café, the blog, the mini homepage, or the homepage. In addition, the network interface unit 140 may further include communication functions such as a function of receiving the broadcast, a mobile communication function, a local area communication function, and location identification communication function. The network interface unit 140 may be defined as a communication unit. The functions of the network interface unit 140 are not limited to the above described examples.

The user device 100 may receive the contact item information from among at least one other user device, at least one service, and at least one server through the network interface unit 140. The other user device is a user device registered in the storage unit 130, and the user device that is used by the user of the user device 100. For example, if the user device 100 is the mobile phone, the other user devices may include the PC of the user, or iPhone of the user. The service refers to the Internet service, which may provide the contact item information list, such as an address book of Google mail, or a friends list of Facebook. The server may generate the contact item information list based on the contact item information collected from the devices connected through the network, and provides each of the devices with the generated contact item information list. In addition, the server may be referred to as a contact item information list managing server.

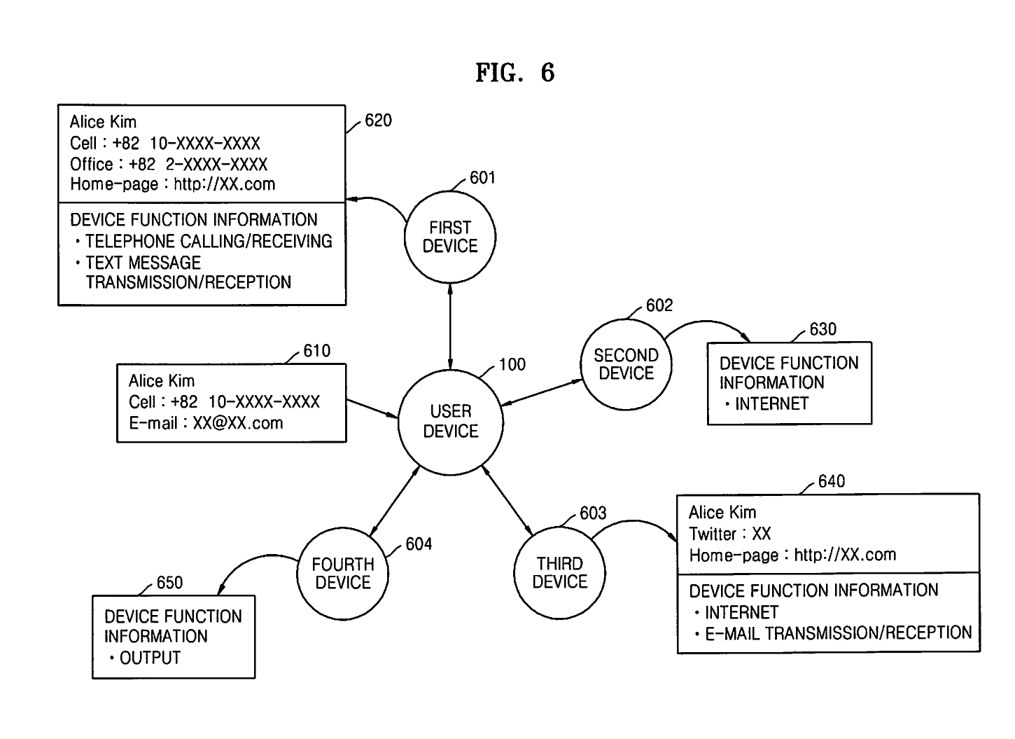

FIG. 6 shows an example of a configuration of network that collects the contact item information included in the contact item information list. FIG. 6 shows an example of the network configuration for receiving the contact item information from at least one available user device, and first through fourth devices 601 through 604 are the user devices that may be used by the user registered in the user device 100.

For example, the first through fourth devices 601 through 604 are user devices having a network function and managed by an application program such as the communicator for generating the contact item information list according to the present embodiment, for example, the PC of the user, the mobile phone of the user, the iPad of the user, the iPhone of the user, and the IPTV of the user.

Registration information of the first through fourth devices 601 through 604 may be stored in the storage unit 130 in advance by the user. The contact item information may include at least the address book data and the information about the functions of the device. The contact item information may further include the information based on the current status information of the contact object as shown in FIG. 3. The device function information is the information about the functions supported by the user device, for example, information about a telephone calling/receiving function, text message transmission/reception information, and Internet function.

When the user device 100 includes the contact item information about Alice Kim as shown in 610 of FIG. 6, the user device 100 may receive the contact item information stored in the first through fourth devices 601 through 604 through the network interface unit 140. The user device 100 connects the received contact item information to the contact object to generate the contact item information list about the contact object, and manages the contact item information list of the contact object.

FIG. 6 shows the contact item information of Alice Kim for the convenience of description, however, the contact item information about other contact objects may be transmitted from the first through fourth devices 601 through 604. The user device 100 may also generate the contact item information list including the contact items of other contact objects. The contact item information stored in the first through fourth devices 601 through 604 may be transmitted upon a request from the user device 100, may be transmitted at a predetermined period, or may be transmitted whenever the contact item information is updated in each of the first through fourth user devices 601 through 604. The user device 100 may generate the contact item information list so that the contact items transmitted from the first through fourth devices 601 through 604 do not overlap each other.

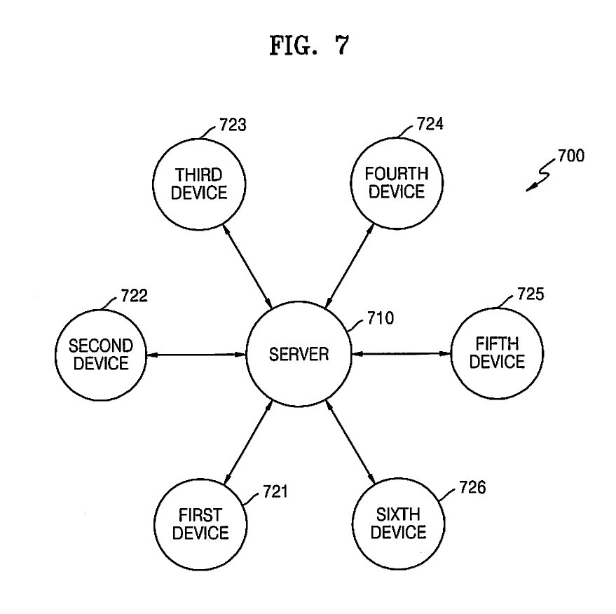

FIG. 7 shows another example of a network configuration for collecting the contact item information included in the contact item information list. The contact item information of FIG. 7 may include the address book data, the device function information, and the current status information of the contact object shown in FIG. 3. The device function information is the same as the device function information shown in FIG. 6.

FIG. 7 shows an example of a configuration of the network 700, in which a server 710 receives the contact item information transmitted from first through sixth devices 721 through 726 and transmits the contact item information list of each of the contact objects generated based on the received contact item information to the first through sixth devices 721 through 726. The user device 100 may be one of the first through sixth devices 721 through 726.

The server 710 provides the first through sixth devices 721 through 726 with the contact item information list of at least one contact object according to the request of the first through sixth devices 721 through 726, or provides the first through sixth devices 721 through 726 with the contact item information list at a predetermined period. For example, if the first device 721 is the user device 100, the server 710 may transmit the contact item information list of at least one contact object to the first device 721 according to the request of the first device 721, transmits the contact item information list of at least one contact object to the first device 721 at a predetermined period, or transmits the contact item information list to the first device 721 whenever the contact item information list of at least one contact object is updated.

The server 710 may transmit the contact item information list simultaneously to the first through sixth devices 721 through 726. The server 710 checks whether there is overlapping contact item information to generate the contact item information list, when the contact item information is transmitted from the first through sixth devices 721 through 726.

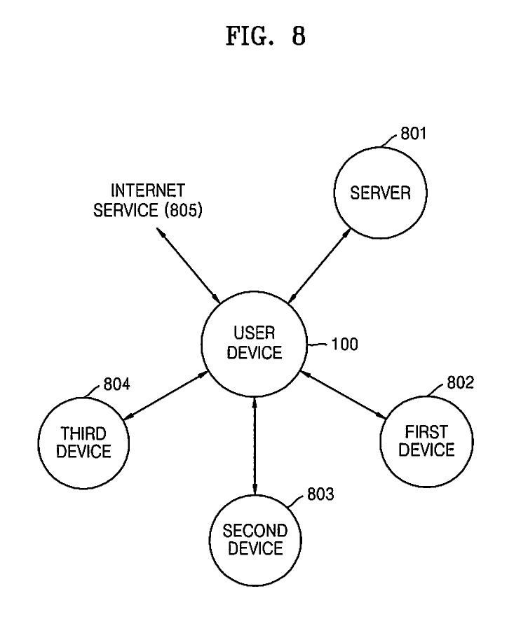

The user device 100 may collect the contact item information based on a network configuration shown in FIG. 8 and generate the contact item information list. FIG. 8 shows another example of a network configuration for collecting the contact item information included in the contact item information list.

The user device 100 receives the contact item information from at least one of a server 801, first through third devices 802, 803, and 804, and at least one of Internet service 805, and generates the contact item information list by linking the contact item information to the contact objects. The first through third devices 802, 803, and 804 are user devices that may be used by the user.

The contact item information may include the address book data, the current status information of the contact object, and the function information of the available user devices (above described device function information) as described with reference to FIGS. 6 and 7. The Internet service 805 may include the address book of Google mail, and a friends list of Facebook. The server 801 may be the server 710 shown in FIG. 7, or an SNS server.

The processor 120 of FIG. 1 controls overall functions of the user device 100, and may be defined as a controller or a micro processor; however, the present invention is not limited thereto. When the contact item information is transmitted based on the network illustrated in FIGS. 6 through 8, the processor 120 links the received contact item information to the contact object to generate the contact item information list of each contact object in one of the formations shown in FIGS. 2 through 5, and stores the generated contact item information list in the storage unit 130. When the contact item information list is requested via the input unit 111, the processor 120 reads the contact item information list stored in the storage unit 130 to output the contact item information list to the output unit 112.

The processor 120 may load a program for executing the method of managing the contact item information stored in the storage unit 130. The program may be stored in the storage unit 130 when the user device 100 is manufactured; however, it may also be downloaded from a server (not shown) through the network interface unit 140 and then stored in the storage unit 130. The server (not shown) may be a server such as an App store server (not shown); however, the present invention is not limited thereto. In addition, the method of managing the contact item information may be referred to as a contact item link method.

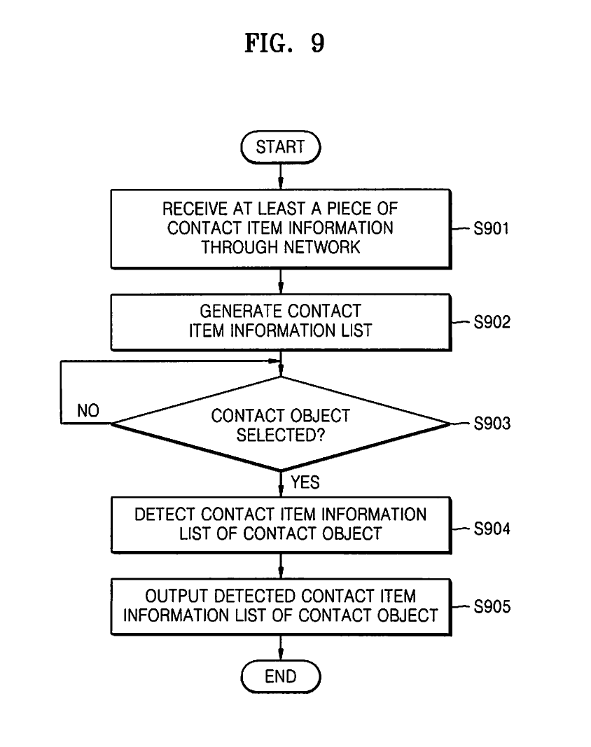

The processor 120 may operate as shown in FIG. 9. FIG. 9 is a flowchart illustrating the method of managing the contact item information in the user device 100 according to an embodiment of the present invention.

Referring to FIG. 9, the processor 120 receives at least a piece of contact item information through the network interface unit 140 in step S901. The contact item information may be transmitted from among at least one available user device, at least one service, and the server illustrated in FIGS. 6 through 8. The at least one available user device is the user device registered in the user device 100. The contact item information may include at least the address book data and the information about the functions of the available user device. The contact item information may further include the current status information of each contact object.

The processor 120 generates the contact item information list by linking the contact item information to the contact object, and stores the generated contact item information list in the storage unit 130 in step S902. When the contact item information list is stored in the storage unit 130 in advance, the processor 120 combines the received contact item information with the contact item information stored in the storage unit 130 in step S902. When the contact item information is combined, the processor 120 makes sure the contact item information does not overlap with each other.

When the contact object is selected via the input unit 111, in steps S903 and S904 the processor 120 detects the contact item information list of the selected contact object from the contact item information list generated in step S902, and outputs the list in step S905.

On the other hand, selection of the contact object performed via the input unit 111 may be performed based on the contents, based on the contact lists, or by using a keyword such as a name or alias of the contact object.

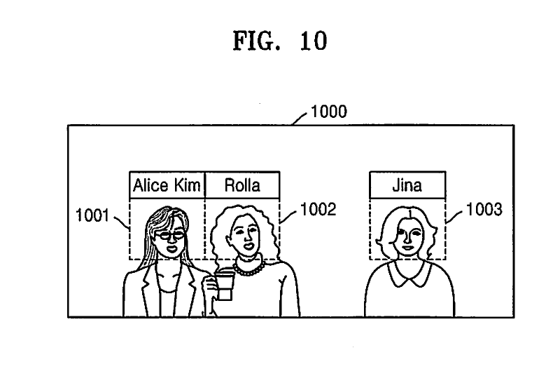

When the contact object is selected based on the contents, the selection may be performed based on images shown in FIG. 10. FIG. 10 is a diagram illustrating a method of selecting the contact object by using the image-based contents. When the image shown in FIG. 10 is output on the output unit 112 and the image is selected via the input unit 111, the processor 120 detects identification information such as information of an image provider, a website, an Internet café, a blog, a mini-homepage, or a homepage on which the image is uploaded. The identification information may be detected from meta-data of the image. The processor 120 detects the contact item information list of the contact object based on the detected identification information from the contact item information list stored in the storage unit 130.

Otherwise, the contact object may be selected by touching a face of an object included in the image of FIG. 10. That is, when the face of the object is touched via the input unit 111, the processor 120 performs an image recognition process or a face recognition process based on image information of a certain area around the touched point in order to detect the identification information of the object. For example, the processor 120 may detect the identification information of the selected object by using one of a method of extracting an eigenvector of the image by using a Karhunen-Loeve (KL) conversion, a method of using Huffman coding that extracts directional information and magnitude information of gradient from the image, and a method of extracting features of the image by using distances between eyes, nose, and mouth.

If an object 1001 is touched in the image 1000, the processor 120 detects Alice Kim as the identification information and detects the contact item information list of Alice Kim from the contact item information lists stored in the storage unit 130. To this end, the storage unit 130 stores an application program for recognizing images, and the processor 120 uses the application program.

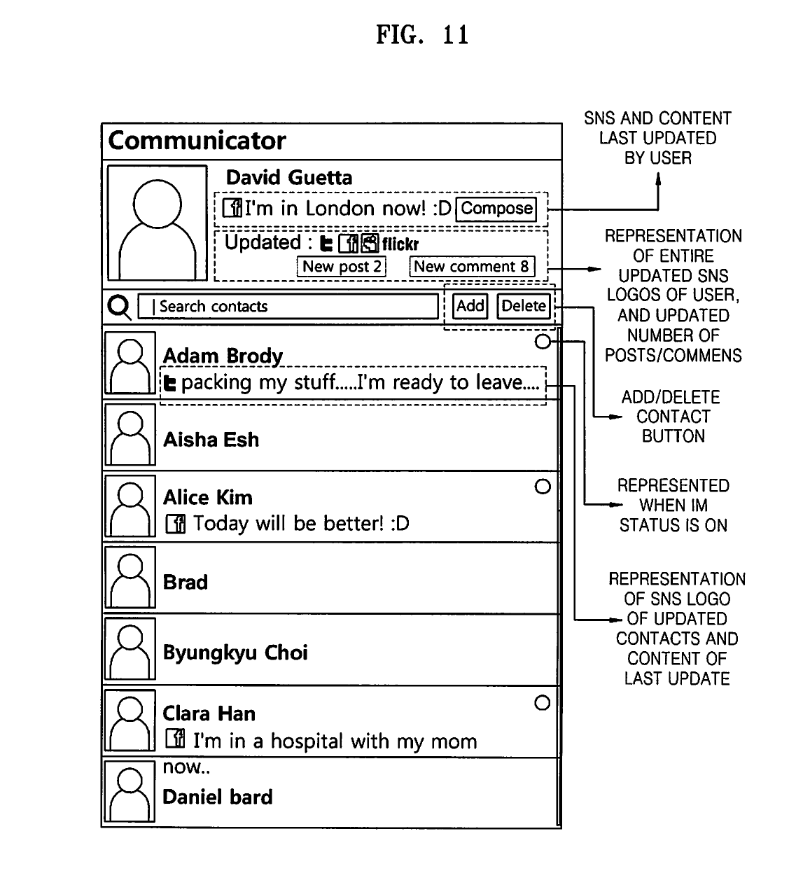

FIG. 11 is a diagram illustrating a method of selecting the contact object based on the contact list. The contact list shown in FIG. 11 is output to the output unit 112 upon request of the user via the input unit 111. When the contact list shown in FIG. 11 is displayed on the output unit 112 and the contact object is selected via the input unit 111, the processor 120 detects the contact item information list of the selected contact object from the contact item information lists stored in the storage unit 130.

The method of selecting the contact object based on the keyword may be performed by inputting key information based on the name or alias of the contact object directly by the user via the input unit 111.

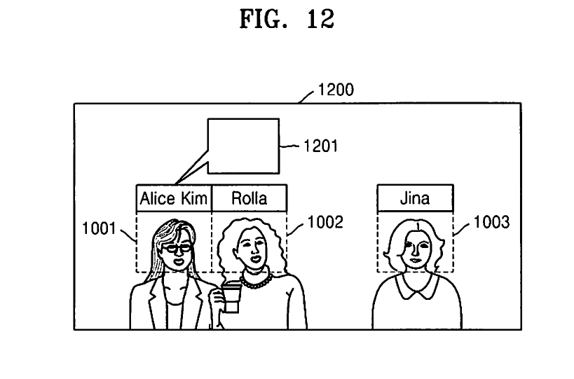

The processor 120 outputs the detected contact item information list to the output unit 112 in step S905. The contact item information list output to the output unit 112 may be displayed as a pop-up in the original image in a shape of a speech balloon as at 1201 as shown in FIG. 12, or may be displayed as a list shown in FIGS. 2 through 5. FIG. 12 shows an example of a screen displaying the contact item information list.

If the contact object selected in step S903 is a plurality of objects included in the image 100, the processor 120 may output the contact item information lists of the plurality of objects to the output unit 112.

In addition, the user device 100 may select the contact object while receiving a broadcasting program. In this case, an operation of receiving the broadcasting program may be added between steps S902 and S903 in FIG. 9. However, the addition of the step of receiving the broadcasting program is not limited to the above example.

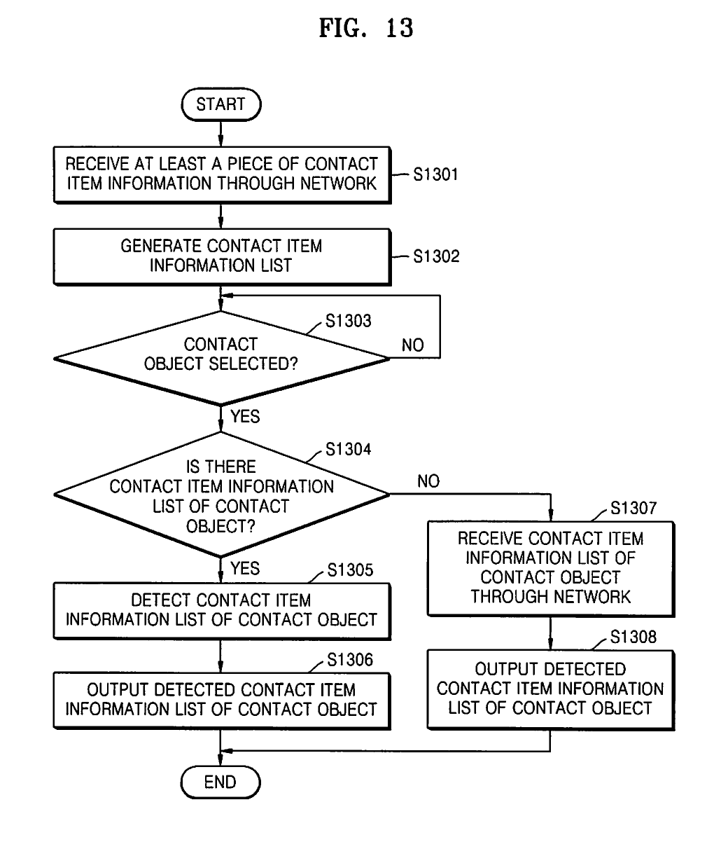

When the contact object is selected in the method illustrated in FIG. 10 based on a certain image, by using the keyword, or based on the contact list during receiving the broadcasting program, the processor 120 may detect the contact item information list of the selected object as in step S904 and outputs the detected contact item information list to the output unit 112. The certain image may be an image included in the broadcasting program that is currently watched. Therefore, when an object included in the certain image is selected as the contact object and the contact item information list about the selected object does not exist in the storage unit 130 of the user device 100, the processor 120 may receive the contact item information list of the selected contact object through the network interface unit 140 and output the contact item information list to the output unit 112. This will be described in more detail below with reference to FIG. 13.

The processor 120 may operate as illustrated in FIG. 13. FIG. 13 is a flowchart illustrating a method of managing contact item information in the user device 100, according to another embodiment of the present invention.

Steps S1301, S1302, S1303, S1305, and S1306 of FIG. 13 are the same as steps of S901 through S905, and thus, detailed descriptions of these steps will not be provided here.

In step S1304 of FIG. 13, the processor 120 checks whether the contact item information list of the currently selected contact object is stored in the storage unit 130. As a result of the checking, if the contact item information list is not stored in the storage unit 130, the processor 120 receives the contact item information list of the selected contact object through the network interface unit 140 and the network in step S1307. The contact item information list of the selected contact object may be received through the network illustrated in FIGS. 6 through 8.

The processor 120 outputs the contact item information list received in step S1307 to the output unit 112 in step S1308.

However, if a plurality of objects are included in an image-based content, the object 1001 is selected as the contact object, and if the contact item information list of the object 1001 does not exist in the storage unit 130 as shown in FIG. 10, a query asking whether another contact object is to be selected since there is no contact item information list of the currently selected contact object is output to the output unit 112 before step S1307. Accordingly, if another object is selected as the contact object via the input unit 111, the contact item information list of the selected contact object is detected and output from the storage unit 130. Here, a plurality of objects may be selected as another contact objects. If another contact object is not selected or the contact item information list of another contact object is not stored in the storage unit 130 either, the processor 120 may repeatedly perform steps S1307 and S1308.

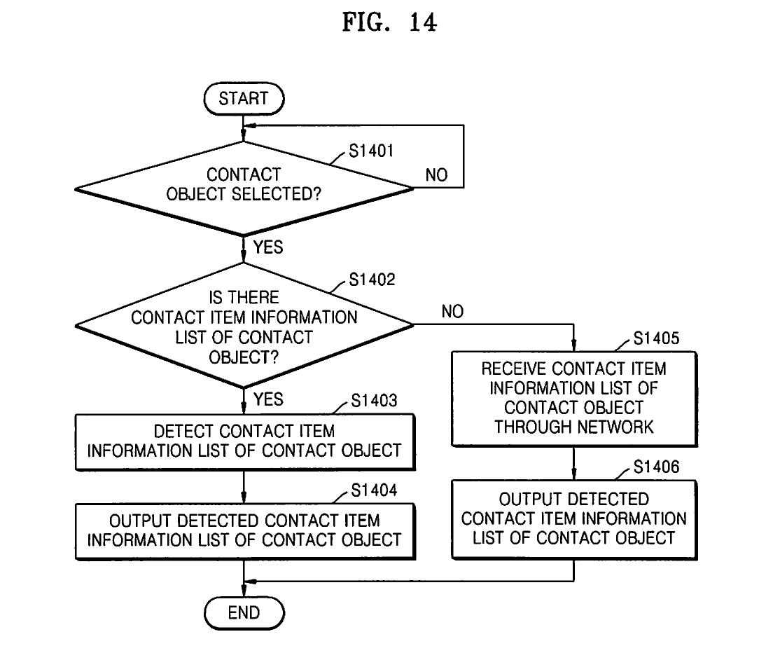

The processor 120 may operate as illustrated in FIG. 14. FIG. 14 illustrates a method of managing the contact item information list including operations of checking whether there is the contact item information list of the selected contact object in the storage unit 130, and receiving the contact item information list through the network and outputting the received contact item information list if there is no contact item information list of the contact object.

FIG. 14 is flowchart illustrating a method of managing the contact item information list in the user device 100, according to another embodiment of the present invention. Step S1401 in FIG. 14 is the same as step S903 in FIG. 9, steps S1403 and S1404 are the same as steps S904 and S905 of FIG. 9, and steps S1402, S1405, and S1406 are the same as steps S1304, S1307, and S1308 of FIG. 13. Therefore, steps S1402, S1405, and S1406 of FIG. 14 may be modified as steps S1304, S1307, and S1308 of FIG. 13.

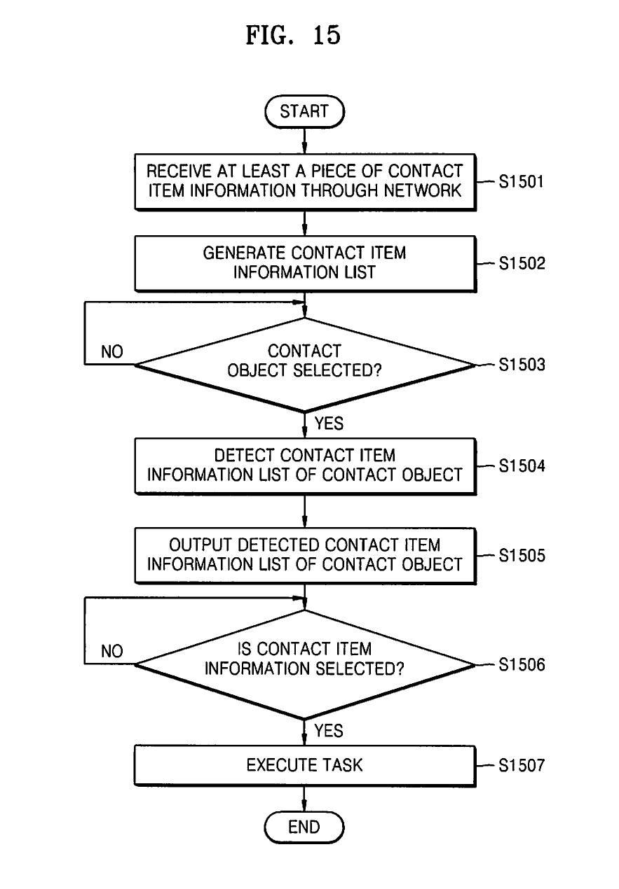

The processor 120 may operate as illustrated in FIG. 15. FIG. 15 is a flowchart illustrating a method of managing the contact item information list in the user device 100, according to another embodiment of the present invention.

FIG. 15 further illustrates an operation of executing a task according to the contact item information in addition to the flowchart of FIG. 9. Therefore, steps S1501 through S1505 of FIG. 15 are the same as steps S901 through S905 of FIG. 9, and thus, detailed descriptions of these steps are not provided here.

When at least a piece of contact item information is selected based on the contact item information list of the contact object output to the output unit 112 in step S1506, the processor 120 executes the task according to the selected contact item information in step S1507.

The execution of the task in step S1507 may be performed as illustrated in FIG. 2. That is, the processor 120 determines whether the selected contact item information may be executed by the task execution unit 150 of the user device 100 based on the information of available user devices that may execute the task based on the selected contact item information. The information of the available user device is stored in the storage unit 130; however, it may be temporarily stored in the processor 120 when the information is included in the contact item information list of the detected contact object.

As a result of determination, if the task can be executed by the task execution unit 150, the processor 120 executes the task based on the selected contact item information by controlling the task execution unit 150. However, if the task cannot be executed by the task execution unit 150 or there is an available user device prior to the user device 100 in executing the task, the processor 120 transmits a task execution command based on the selected contact item information to the corresponding user device through the network interface unit 140. Accordingly, the corresponding user device executes the task based on the selected contact item information.

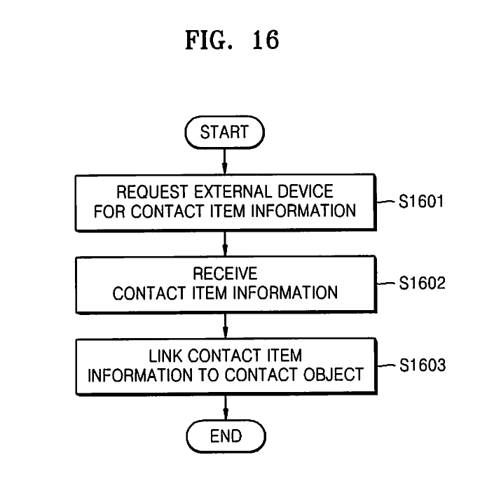

The processor 120 may operate as illustrated in FIG. 16. FIG. 16 is a flowchart illustrating a method of managing the contact item information in the user device 100, according to another embodiment of the present invention.

The processor 120 requests an external device for the contact item information relating to the contact object through the network interface unit 140 in step S1601. The external device may be at least one of at least one user device, at least one service, and at least one server connected via a network. The user device, the service, and the server are illustrated in FIGS. 6 through 8.

The requested contact item information is received from the external device through the network interface unit 140 in step S1602, the processor 120 generates the contact item information list of the contact object by linking the received contact item information to the contact object in step S1603. The generated contact item information list is illustrated in FIGS. 2 through 5.

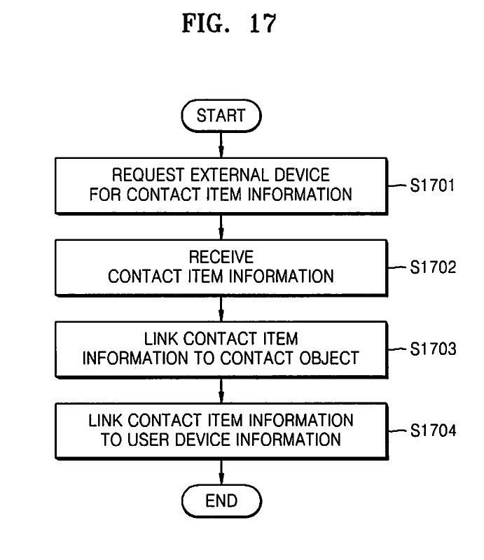

The processor 120 may operate as illustrated in FIG. 17. FIG. 17 is a flowchart illustrating a method of managing the contact item information in the user device 100, according to another embodiment of the present invention.

FIG. 17 additionally illustrates an operation of the contact item information to the user device information in addition to the flowchart of FIG. 16. Therefore, steps S1701 and S1702 are the same as steps S1601 and S1602, and detailed descriptions of these steps are not provided here.

In step S1703, the processor 120 links the received contact item information to the contact object. Next, in step S1704, the processor 120 links the contact item information to the available user device information. The available user device information may be received based on the network shown in FIG. 6, or may be stored in the storage unit 130. Through steps S1703 and S1704, the processor 120 may generate the contact item information list of the contact object.

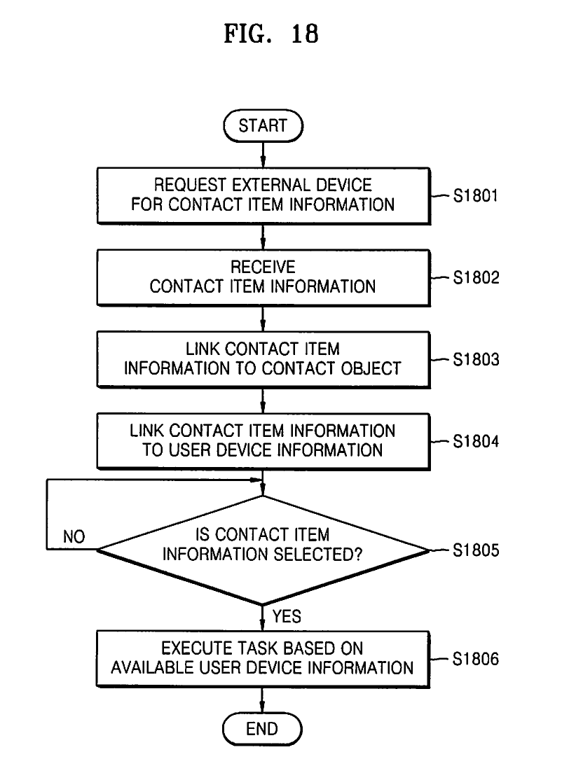

The processor 120 may operate as illustrated in FIG. 18. FIG. 18 is a flowchart illustrating a method of managing the contact item information in the user device 100, according to another embodiment of the present invention.

FIG. 18 further illustrates an operation of executing a task according to the selected contact item information in addition to the flowchart of FIG. 17. Therefore, steps S1801 through S1804 of FIG. 18 are the same as steps S1701 through S1704 of FIG. 17, and thus, detailed descriptions of above operations are not provided here.

In step S1805, when the contact item information is selected via the user interface unit 110, the processor 120 executes the task based on the available user device information in step S1806. That is, as described with reference to FIG. 2, the task may be executed based on the user device information. Step S1806 may be performed similar to step S1507.

The program for executing the method of managing the contact item information can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing contact item information, the method comprising:
requesting an external device for contact item information relating to a contact object;
receiving the requested contact item information from the external device; and
linking the received contact item information to the contact object.

2. The method of claim 1, further comprising linking the contact item information to information about available user devices.

3. The method of claim 2, further comprising executing a task based on the selected contact item information based on the available user device information.

4. The method of claim 1, wherein the external device is at least one of at least one user device, at least one service, and at least one server that are connected to each other through a network.

5. The method of claim 1, wherein the contact object is selected based on identification information of content.

6. The method of claim 1, wherein the contact object is selected based on identification information of an object included in content.

7. A computer readable recording medium having embodied thereon a computer program for executing a method of managing contact item information, comprising:
a first code segment for requesting an external device for contact item information relating to a contact object;
a second code segment for receiving the requested contact item information from the external device;
a third code segment for linking the received contact item information to the contact object;
a fourth code segment for linking the contact item information to information about available user devices; and
a fifth code segment for executing a task based on the selected contact item information based on the available user device information.

8. A user device comprising:
a network interface unit interfacing with a network; and
a processor transmitting a signal for requesting contact item information relating to a contact object to an external device through the network interface unit, and linking the contact item information that is transmitted through the network interface unit to the contact object.

9. The user device of claim 8, wherein the processor links the contact item information to information about available user devices.

10. The user device of claim 9, wherein the processor executes a task according to the selected contact item information based on the available user device information.

11. The user device of claim 8, wherein the external device is at least one of at least one user device, at least one service, and at least one server that are connected to each other through a network.

12. The user device of claim 8, wherein the processor selects the contact object based on identification information of content.

13. The user device of claim 8, wherein the processor selects the contact object based on identification information of an object included in content.
